(19) United States
(12) Patent Application Publication
(10) Pub. No.: US 2018/0336614 A1
(43) Pub. Date: Nov. 22, 2018

(54) PERSONALIZED CUSTOMIZATION MARKETING SYSTEM FOR ELECTRONIC PRODUCT ACCESSORY AND METHOD THEREOF

(71) Applicant: E&C Smart Link Technology Co. Ltd, Shenzhen (CN)

(72) Inventor: Liming REN, Shenzhen (CN)

(21) Appl. No.: 15/636,662

(22) Filed: Jun. 29, 2017

(30) Foreign Application Priority Data
May 17, 2017 (CN) 201710349728.9

(51) Int. Cl. G06Q 30/06; B23K 26/362

(52) U.S. Cl. CPC G06Q 30/0621; B23K 26/362

(57) ABSTRACT

The disclosure provides a personalized customization marketing system for an electronic product accessory and a method thereof. The system comprises a client, a preprocessing end and a processing end. The client is provided with an application software for a customer to select personalized selection parameter of the electronic product accessory and generates an effect picture according to the personalized selection parameters of the customer, wherein the personalized selection parameters include a type, a line length, a color and a processing methods. The preprocessing end produces semi-finished products of the electronic product accessory for the customer to combine and select. The processing end is in communication with the client and processes and combines the semi-finished products of the electronic product accessory provided by the preprocessing end into a finished product of the electronic product accessory according to the personalized selection parameters of the customer.

### CROSS-REFERENCE TO RELATED APPLICATIONS

This application is based upon and claims priority to Chinese Patent Application No. 201710349728.9, filed on May 17, 2017, the entire contents of which are incorporated herein by reference.

### TECHNICAL FIELD

The present disclosure relates to the field of marketing technologies, and more particularly to a personalized customization marketing system for an electronic product accessory.

### BACKGROUD

Existing electronic digital accessory products such as electric wire and headphone can only be purchased from industrialized products of mass production, for example, if a consumer wants to purchase a USB data line, he/she can only purchase one with the length, color, plug appearance and the like set by one brand owner; if to realize personalized customization, the cost will be very high.

### SUMMARY

In order to solve the above problem, the present disclosure provides a personalized customization marketing system for an electronic product accessory and a method thereof.

A personalized customization marketing system for an electronic product accessory includes a client, a preprocessing end and a processing end; the client is provided with an application software for a customer to select the type, line length, color and processing method of an electronic product accessory and generates an effect picture according to the personalized selection parameters of the customer; the preprocessing end produces semi-finished products of the electronic product accessory for the customer to combine and select; the processing end is in communication with the client and processes and combines the semi-finished products of the electronic product accessory provided by the preprocessing end into a finished product of the electronic product accessory according to the personalized selection parameters of the customer.

As a preferred embodiment of the disclosure, the system further includes a surface treatment end, which includes an automatic laser equipment that conducts laser treatment on the surface of the finished product of the electronic product accessory.

The disclosure further provides a method applied to a personalized customization marketing system for an electronic product accessory described as above, the method including the following steps:

S1: developing application software at a client;

S2: producing, by a preprocessing end, semi-finished products of an electronic accessory product for a customer to combine and select;

S3: selecting, by a customer, a preferred one of the semi-finished products in the application software, and generating, by the application software, an effect picture for the customer as a reference;

S4: acquiring, by a processing end, the processing parameter of the customer from the application software at the client, and processing, by the processing end, the semi-finished products into a finished product of the electronic product accessory; and

S5: conducting laser treatment on the surface of the finished product according to a requirement of the customer, and then packaging and delivering the finished product.

The disclosure has benefits as follows:

1. By developing and setting the application software at the client, a customer selects a favorite semi-finished product of an electronic product accessory through the application software, including the type, color, line length and processing method of the electronic product accessory, and the application software generates an effect picture for the customer as a reference according to the parameter information about the personalized selection of the customer; the preprocessing end produces semi-finished products of the electronic product accessory, the processing end is in communication with the client to acquire the customer's personalized customization parameters and information and receives the semi-finished products from the preprocessing end to process them into a finished product of the electronic product accessory, thereby meeting the personalized selection requirement of different groups of people and improving the level of fitting.

2. Resource configuration is more optimized, selling pertinence is higher and unsalable cost of universal electronic product accessories is lowered.

### BRIEF DESCRIPTION OF THE DRAWINGS

The technical scheme of the present disclosure and other benefits thereof will become apparent from the following detailed description of the embodiments of the disclosure and from the accompanying drawings.

FIG. 1 is a structure diagram of a personalized customization marketing system for an electronic product accessory.

FIG. 2 is a flowchart of a personalized customization marketing method for an electronic product accessory.

### DETAILED DESCRIPTION OF THE EMBODIMENTS

In order to better illustrate the technical means adopted by the disclosure and benefits thereof, the disclosure is described below in further detail in conjunction with accompanying drawings and preferred embodiments.

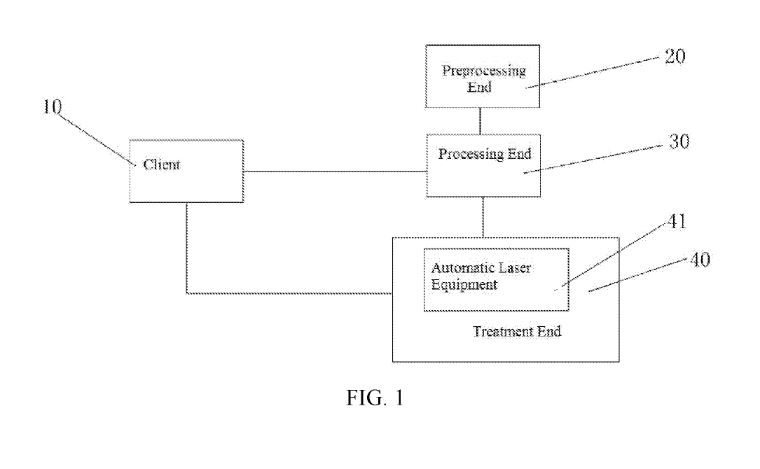

Please refer to FIG. 1, a personalized customization marketing system for an electronic product accessory is provided, which includes a client 10, a preprocessing end 20 and a processing end 30; the client 10 is provided with an application software for a customer to select the type, line length, color and processing method of an electronic product accessory and generates an effect picture according to the personalized selection parameters of the customer; the preprocessing end 20 produces semi-finished products of the electronic product accessory for the customer to combine and select; the processing end 30 is in communication with the client 10 and processes and combines the semi-finished products of the electronic product accessory provided by the preprocessing end 20 into a finished product of the electronic product accessory according to the personalized selection parameters of the customer.

Specifically, the client 10 includes mobile phones, tablet computers and desktop computers, and the customer may select according to practical convenience.

Specifically, the electronic product accessory includes headphones, charging cables, data transmission lines, mini LED lamps, mobile phone shells, power strips, chargers and so on.

Specifically, the semi-finished products of the electronic product accessory include connection lines, earplugs of different models, connectors of different types, power sockets of different types, mobile phone shells matched with different shapes of mobile phones, and so on.

Since components for electronic product accessories generally have high universality, for example, connection lines, connectors and earplugs are of common models, connection lines for Apple phones and Andriod phones are only different in connector shape, however, different people have different combinations for the length and color of connection lines and the shape of phone insertion ports, therefore, lots of universal components of electronic product accessories are provided as semi-finished products at the semi-finished product end, so that a customer selects different semi-finished products to process into a finished product of an electronic product accessory suitable for himself/herself, the production period is short, the fitting of the product is high, the sale period is short and the marketing efficiency is high.

Through network and software technologies, customers may implement personalized selection of commodity components under a given condition, and meanwhile may see an effect picture of the selected commodity through the application software, so that personalized product customization may be finally achieved.

As a preferred embodiment of the disclosure, the system further includes a surface Treatment end 40, which includes an automatic laser equipment 41 that conducts laser treatment on the surface of the finished product of the electronic accessory product so as to add a corporate logo identifier or a personalized pattern.

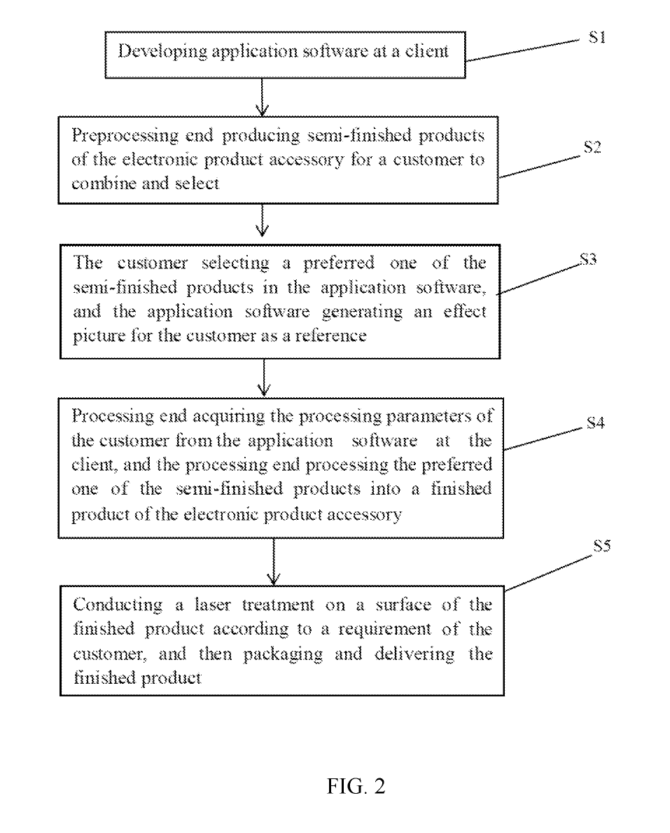

Please refer to FIG. 2, the present disclosure further provides a method applied to a personalized customization marketing system for an electronic product accessory described as above, and the method includes the following steps:

S1: application software is developed at a client 10.

S2: a preprocessing end 20 produces semi-finished products of an electronic accessory product for a customer to select and combine.

S3: a customer selects a preferred one of the semi-finished products in the application software and the application software generates an effect picture for the custome ras a reference.

S4: a processing end 30 acquires the processing parameter of the customer from the application software at the client 10, and processes the semi-finished products into a finished product of the electronic product accessory.

S5: laser treatment is conducted on the surface of the finished product according to a requirement of the customer, and then the finished product is packaged and delivered.

Specifically, the application software may be applied to a sales platform, for example, Jingdong, Alibaba, Amazon, etc.

Specifically, the application software may be applied to Windows platform, Andriod platform and iOS platform.

In a specific embodiment, when a customer selects to purchase a USB data line, the client 10 provides the following options (Table 1):

TABLE 1
Options and Parameters for USB data lines

| | Length | | | | | |
|---|---|---|---|---|---|---|
| | 0.5 m | 1.0 m | 1.5 m | 1.83 m | 2.0 m | 3.0 m |
| Line Color | Red | Gray | Yellow | Green | Blue | Pink |
| Shell Color | Red | Gray | Yellow | Green | Blue | Pink |
| Characters | Single | Double | Single | Double | Horizontal | Vertical |
| | Surface | Surfaces | End | Ends | Arrangement | Arrangement |
| Patterns | Single | Double | Single | Double | Horizontal | Vertical |
| | Surface | Surfaces | End | Ends | Arrangement | Arrangement |

A customer selects favorite parameters in front of a mobile phone or computer, and the client generates an effect picture. After the customer is satisfied and places an order, the processing end 30 acquires information from the client 10 and processes and combines the semi-finished product of the electronic product accessory provided by the preprocessing end 20 into a finished product of the electronic product accessory. Then, the finished product is delivered to the customer.

The personalized customization marketing system and method for an electronic product accessory provided by the disclosure convert the traditional universal electronic product sale mode into a personalized customization production processing mode, thus, the production mode is more flexible and can meet the personalized selection requirement of different groups of people, the processing mode of producing a finished product docking the personalized selections by large quantities of semi-finished products has short processing period, the product docking the customer has a high degree of satisfaction, being beneficial for optimizing resource configuration and accelerating product circulation speed, and providing the market with a brand new high-efficiency personalized customization marketing mode for an electronic product accessory.

To sum up, for the ordinary technical staff in this field, various other corresponding changes and deformations may be made according to the technical scheme and technical idea of the disclosure, and these changes and deformations are intended to be within the scope of protection of claims appended herein.

What is claimed is:

1. A personalized customization marketing system for an electronic product accessory, comprising:
a client, provided with an application software for a customer to select personalized selection parameters of the electronic product accessory and generating an effect picture according to the personalized selection parameters of the customer, wherein the personalized selection parameters comprise a type, a line length, a color and a processing method;
a preprocessing end, for producing semi-finished products of the electronic product accessory for the customer to combine and select; and
a processing end, in communication with the client and for processing and combining the semi-finished products of the electronic product accessory provided by the preprocessing end into a finished product of the electronic product accessory according to the personalized selection parameters of the customer.

2. The personalized customization marketing system for an electronic product accessory according to claim 1, further comprising: a surface treatment end comprising an automatic laser equipment for conducting laser treatment on a surface of the finished product of the electronic product accessory.

3. The personalized customization marketing system for an electronic product accessory according to claim 1, wherein the electronic product accessory comprises data lines, charging connection lines, data transmission connection lines, headphones and chargers for an Andriod platform or a Lightning platform.

4. A method applied to the personalized customization marketing system for an electronic product accessory according to claim 1, wherein the method comprises steps of:
S1: developing application software at a client;
S2: producing, by a preprocessing end, semi-finished products of the electronic product accessory for a customer to combine and select;
S3: selecting, by the customer, a preferred one of the semi-finished products in the application software, and generating, by the application software, an effect picture for the customer as a reference;
S4: acquiring, by a processing end, the processing parameters of the customer from the application software at the client, and processing, by the processing end, the preferred one of the semi-finished products into a finished product of the electronic product accessory; and
S5: conducting a laser treatment on a surface of the finished product according to a requirement of the customer, and then packaging and delivering the finished product.

5. The method according to claim 4, wherein the application software is applicable to an online sales platform.

6. The method according to claim 4, wherein the application software is applicable to a Windows platform, an Andriod platform and an iOS platform.
